(19) United States
(12) Patent Application Publication
(10) Pub. No.: US 2007/0255581 A1
(43) Pub. Date: Nov. 1, 2007

(54) ONLINE REAL ESTATE MARKETPLACE

(76) Inventors: JAY P. OTTO, Pflugerville, TX (US); Damon Flowers, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 11/740,047

(22) Filed: Apr. 25, 2007

Related U.S. Application Data
(60) Provisional application No. 60/795,070, filed on Apr. 26, 2006.

(51) Int. Cl. G06Q 10/00; G06F 15/02; G06Q 30/00

(52) U.S. Cl. 705/1; 705/9

(57) ABSTRACT

According to a method of data processing a plurality of buyer profiles are established. Each buyer profile describes one or more attributes of a real property in which a buyer desires to acquire an interest. In addition, at least one owner profile in which an owner describes real property in which an owner holds rights is established. Contents of the owner profile are compared against the plurality of buyer profiles to obtain at least one closely matching buyer profile, and information from the at least one matching buyer profile is transmitted for presentation to the owner.

### PRIORITY CLAIM AND CROSS-REFERENCE

The present application claims priority to U.S. Provisional Patent Application 60/795,070, filed Apr. 26, 2006, which is incorporated herein by reference in its entirety.

### BACKGROUND OF THE INVENTION

1. Technical Field

The present invention relates in general to data processing and, in particular, to an electronic real estate marketplace.

2. Description of the Related Art

Various online real estate marketplace embodiments have been proposed and implemented. In general, such online real estate marketplace embodiments are designed, with some variation, to facilitate through electronic means the operation of the traditional real estate marketplace. For example, owners desiring to sell a property first “list” their properties in an electronic Multiple Listing Service (MLS) under a listing agreement according to which a listing real estate broker/agent (or agency) receives a commission representing a predetermined percentage of the proceeds of any sale during the listing period. Potential buyers then electronically browse the inventory of properties that are listed for sale in the electronic MLS records, for example, utilizing a conventional web browser. If the buyer is able to identify a listed property of interest, the buyer contacts the listing broker/agent or hires a buyer's agent/broker to represent him or her. Through the agency of the real estate broker(s)/agent(s) involved, the buyer and seller negotiate price and other terms and finally consummate the transaction through the execution of a hardcopy contract of sale.

As will be appreciated, such conventional online real estate marketplaces, when commercially implemented, are typically operated by and for the benefit of real estate brokers/agents and provide another avenue for technologically savvy real estate professionals to advertise their services and gain clients and earn commissions in an increasingly competitive marketplace.

### SUMMARY OF THE INVENTION

According to a method of data processing a plurality of buyer profiles are established. Each buyer profile describes one or more attributes of a real property in which a buyer desires to acquire an interest. In addition, at least one owner profile in which an owner describes real property in which an owner holds rights is established. Contents of the owner profile are compared against the plurality of buyer profiles to obtain at least one closely matching buyer profile, and information from the at least one matching buyer profile is transmitted for presentation to the owner.

All objects, features, and advantages of the present invention will become apparent in the following detailed written description.

### BRIEF DESCRIPTION OF THE DRAWINGS

The novel features believed characteristic of the invention are set forth in the appended claims. However, the invention, as well as a preferred mode of use, will best be understood by reference to the following detailed description of an illustrative embodiment when read in conjunction with the accompanying drawings, wherein:

FIG. 1 is a high level block diagram of a data processing environment in which the present invention may advantageously be employed;

FIG. 2 is a more detailed view of the real property marketplace program code of FIG. 1;

FIGS. 3A-3C together for a high level logical flowchart of an exemplary process by which Buyers and Owners interact with the online real property marketplace;

FIG. 4 is an exemplary embodiment of a home page of a website providing an online real property marketplace in accordance with the present invention;

FIG. 5 is an exemplary embodiment of an informational web page of a website providing an online real property marketplace in accordance with the present invention;

FIG. 6 is an exemplary embodiment of a owner profile web page of a website providing an online real property marketplace in accordance with the present invention;

FIG. 7 is an exemplary embodiment of an owner status web page of a website providing an online real property marketplace in accordance with the present invention;

FIG. 8 is an exemplary embodiment of a property location web page of a website providing an online real property marketplace in accordance with the present invention;

FIGS. 9A-9B is an exemplary embodiment of a buyer query web pages of a website providing an online real property marketplace in accordance with the present invention;

FIG. 10 is an exemplary embodiment of a buyer profile web page of a website providing an online real property marketplace in accordance with the present invention;

FIG. 11 is an exemplary embodiment of a personal statement web page of a website providing an online real property marketplace in accordance with the present invention; and

FIG. 12 is an exemplary embodiment of a tagging web page of a website providing an online real property marketplace in accordance with the present invention.

### DETAILED DESCRIPTION OF ILLUSTRATIVE EMBODIMENT(S)

The following description provides an enabling disclosure of specific features of embodiments of the present invention. Those skilled in the art will appreciate that the present invention is subject to numerous variations and the following description is not intended to be exhaustive of all such variations. The description omits certain well known structures and functions to avoid unnecessarily obscuring the salient features of the embodiments of the present invention.

The present invention relates to an online real property marketplace, for example, one implemented as a website hosted on an Internet web server and publicly available for access. The online real property marketplace permits interested parties (referred to herein as Buyers) to make, and real property representatives (referred to herein as Owners) to receive expressions of interest in acquiring rights (e.g., fee simple ownership or leasehold) in real property apart from the conventional broker-controlled real estate listing process. Further, in the real property marketplace, the Owners and/or the Buyers control the dissemination of information identifying themselves and the real property. As will become apparent from the following description, this arrangement is a marked departure from traditional real estate broker-centric arrangements, whether implemented electronically or otherwise.

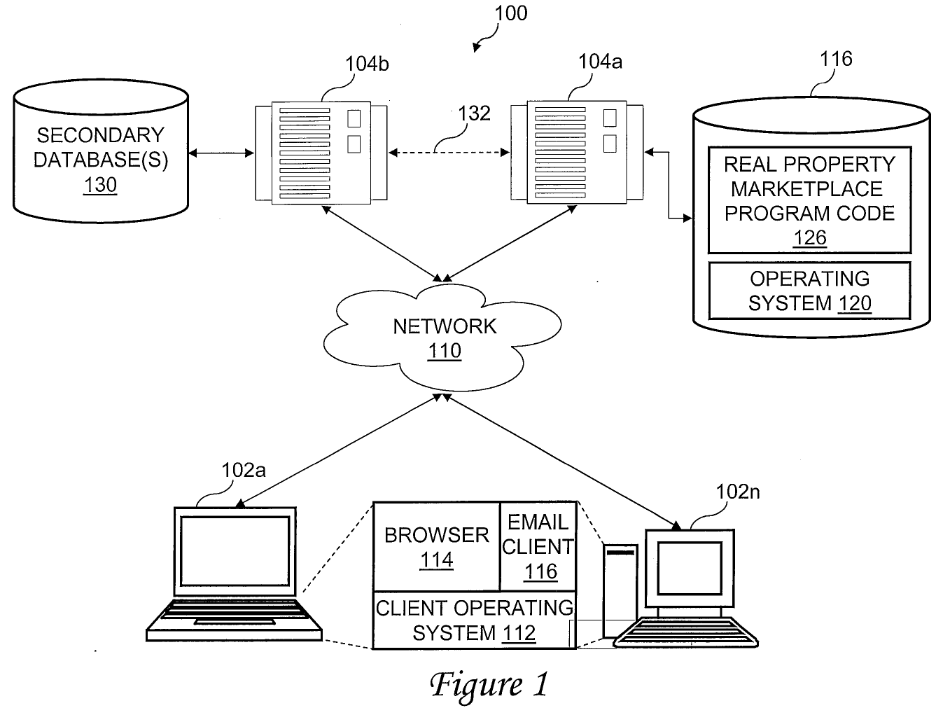

With reference now to FIG. 1, there is illustrated a high level block diagram of an exemplary data processing environment 100 in which the present invention may be practiced. As depicted, data processing environment 100 includes a plurality of client devices 102a-102n in communication with a server system 104a via a network 110, which may comprise one or more wired or wireless, packet or circuit switched communication networks. Network 110 may include, for example, one or more local area networks (LANs) or wide area networks (WANs), such as the Internet.

As shown, each client device 102, which may be, for example, a personal computer system, laptop computer, palmtop computer, personal digital assistant, web-enabled mobile telephone or the like, includes a client operating system 112, which provides a software operating environment for client device 102, as well as a browser 114 that provides an interface (e.g., a graphical user interface (GUI)) through which a user of client device 102 may communicate with one or more of server systems 104 via network 110. For example, in some embodiments, browser 114 may comprise Internet Explorer®, available from Microsoft Corporation of Redmond, Wash. In addition, each client device 102 preferably includes an email client 116. Browser 114, email client 116, and client operating system 112 are preferably stored in non-volatile storage, such as a flash memory, hard disk drive, or optical drive, communicatively coupled to client device 102. Each client device 102 preferably includes a display device as well as a keyboard, graphical pointing device (e.g., mouse or touchpad), touchscreen and/or other user interface device supporting user input.

Server system 104a, which includes processing resources and memory, includes or is communicatively coupled to a non-volatile storage device 116 to execute and/or process program code and data stored therein. The program code stored within non-volatile storage device 116 includes an operating system 120 that provides a software operating environment for server system 104a and real property marketplace program code 126 that provides an online real property marketplace, as described further below. As will be appreciated by those skilled in the art, real property marketplace program code 126 includes instructions that may be executed or processed by server system 104a, and may further include program data.

Server system 104a may optionally be further coupled for communication to one or more secondary database(s) 130 that provide(s) information regarding and/or related to real property. Server system 104a may be coupled to secondary database(s) 130 directly, or alternatively, via another server system 104b coupled to server system 104a by network 110 and/or a private network 132. Secondary database(s) 130 may be maintained, for example, by the same business entity (or an affiliate) as that which operates real property marketplace program code 126. Alternatively or additionally, one or more secondary databases 130 may be operated by a governmental or pseudo-governmental property taxation district (e.g., a county) or an unrelated business entity and may be accessed by server system 104a with or without a fee.

The information in secondary database(s) 130 may provide information regarding each real estate parcel or other legal subdivision of real property (e.g., condominium or apartment or specific leasehold rights). For example, the information may include a property identifier, physical address, legal description, owner, lot dimensions, deed information, valuation information, neighborhood code, governmental jurisdictions, school zoning, age and description of any improvements, historical valuation and market value. Additional information regarding and/or related to real property, for example, street or satellite maps depicting the property location, description of nearby amenities, information regarding service providers that are available to provide services to the users of real property marketplace program code 126, etc. may optionally further be obtained by server system 104a from secondary database(s) 140. The information within secondary database(s) 140 may duplicate or supplement some or all of the information contained within real property marketplace program code 126.

In operation, multiple users stationed at various client systems 102 independently invoke the execution of browser 114 on their client systems 102 to enable independent asynchronous communication with real property marketplace program code 126 on server system 104a via network 110. By facilitating the communication of information between the various participants in the real estate marketplace as described below, greater market efficiency is achieved in that brokers/agents are removed as the gatekeepers to communication between potential parties to a real estate transaction. Moreover, a greater universe of real property is available for potential exchange than the 3 to 5 percent of properties typically listed as “for sale” in traditional multiple listing service (MLS) systems.

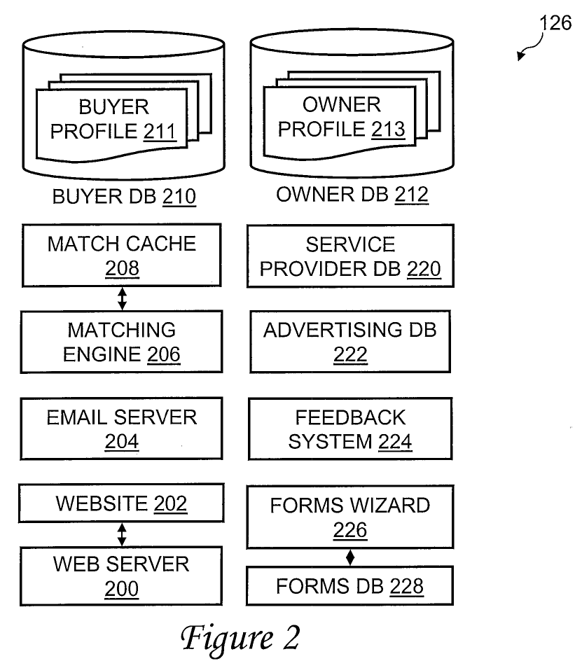

Referring now to FIG. 2, there is depicted a more detailed view of an exemplary embodiment of real property marketplace program code 126 of FIG. 1. As illustrated, real property marketplace program code 126 includes a web server 200 that serves pages of website 202 to browsers 114 of Buyers and Owners through communication on network 110. As described further below, the information presented through website 202 can include not only graphical and/or textual information regarding specific properties, Buyers and Owners, but also additional information such as market information, information regarding available services and service providers, and advertisements. Real property marketplace program code 126 can further include an email server 204 supporting the communication of electronic mail between the participants in the online real property marketplace, a matching engine 206 that matches property, services and/or service providers based upon user-specified or automatically generated criteria, and an optional match cache 208 that temporarily buffers search results of matching engine 206. In addition, real property marketplace program code 126 includes a buyer database (DB) 210 containing buyer profiles 211 of Buyers participating in the online real property marketplace and an owner database (DB) 212 containing owner profiles 213 of Owners participating in the online real property marketplace.

Still referring to FIG. 2, real property marketplace program code 126 may additionally include a service provider database 220 containing listings of service providers available to provide services to participants in the real property marketplace, an advertising database 222 of advertisements to be presented via website 202, for example, in exchange for a fee based upon page views, call-through and/or click-through, and a feedback system 224 through which participants in the real property marketplace are able to provide community-viewable feedback on other participants in the real property marketplace, including Buyers, Owners and/or service providers. Real property program code 126 may additionally include a forms wizard 226 that assists participants in the real property marketplace in selecting an appropriate form from forms database 228 (e.g., contract for sale, service contract, rental agreement, etc.) and populating fields of the selected form.

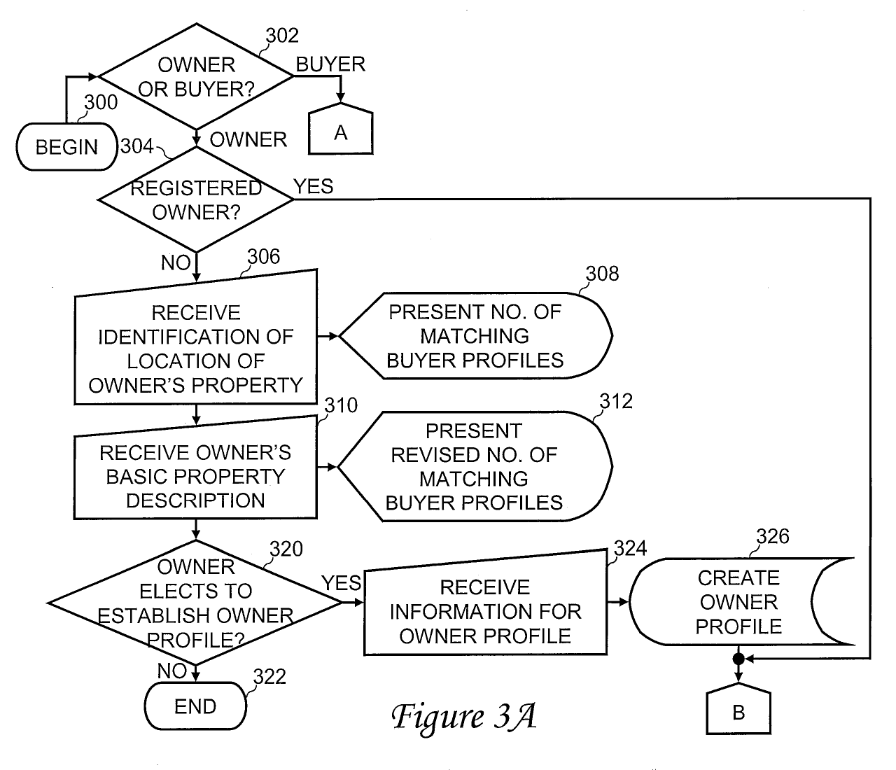

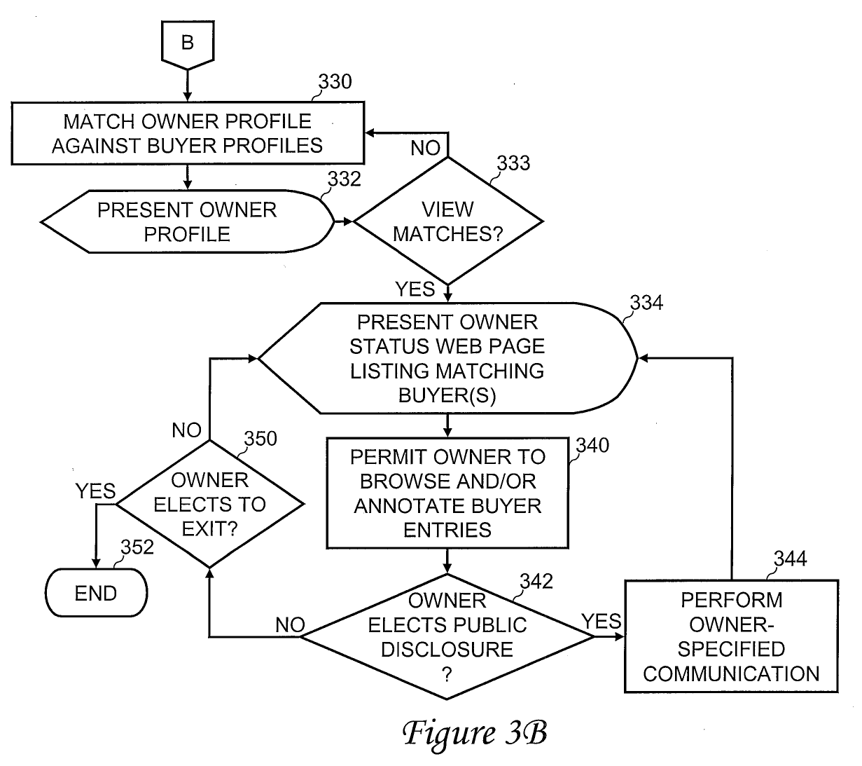

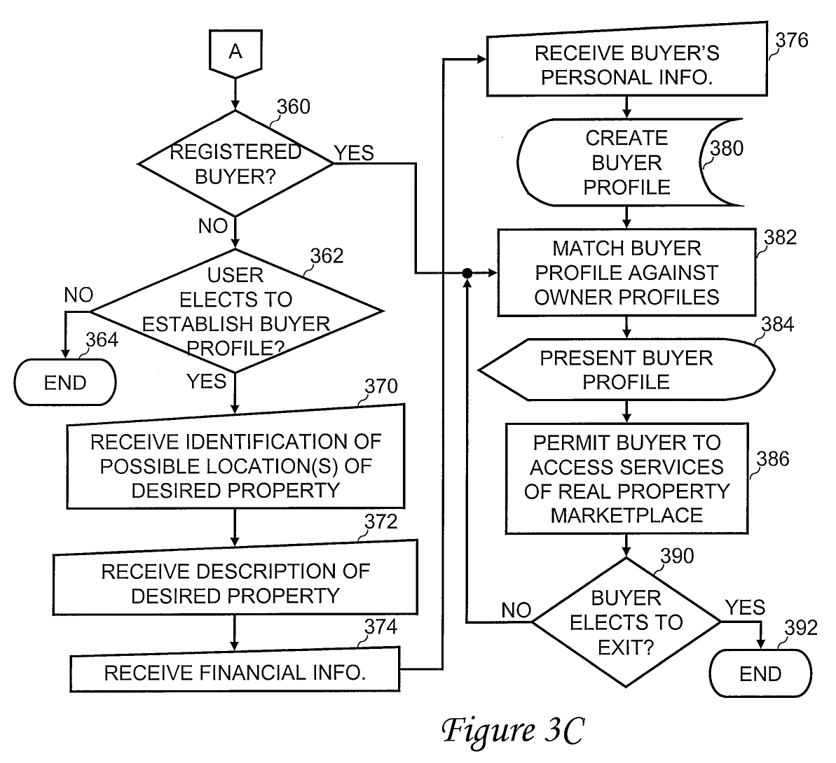

With reference now to FIG. 3, there is illustrated a high level logical flowchart of an exemplary method by which Buyers and Owners can interact via the online real property marketplace provided by real property program code 126. As a logical flowchart, it will be appreciated that the depicted steps are presented in logical rather than chronological order and that the illustrated steps and optionally additional steps may be performed concurrently or in a different order.

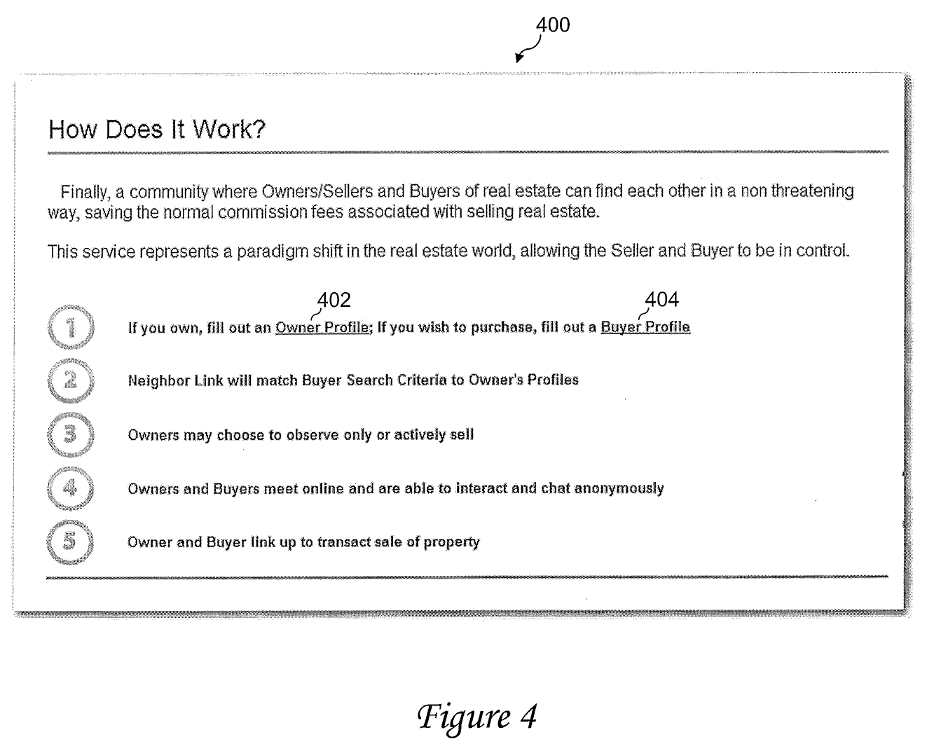

The exemplary process begins at block 300 in response to a user of a client device 102 utilizing a browser 114 to navigate to website 202 of the online real property marketplace. As shown in FIG. 4, home page 400 of website 202, which is first presented to the user, may include a link 402 or other navigation component (e.g., menu item or button) that directs users holding rights in real property to an “Owner” portion of website 202 and a link 404 or other navigation component that directs users wishing to acquire rights in real property to a “Buyer” portion of website 202. As indicated by block 302 of FIG. 3A, in response to the user utilizing a navigation component of home page 400 to navigate to the Owner portion of website 202 (e.g., by “clicking” on link 402), the process passes to block 304 and following blocks, which as described below provide an overview of features available for individuals holding rights in real property. If, on the other hand, the user utilizes a navigation facility of home page 400 to navigate to the Buyer portion of website 202 (e.g., by “clicking” on link 404), the process passes through page connector A to block 360 of FIG. 3C and following blocks, which as described below provide an overview of features available for individuals interested in acquiring rights in real property.

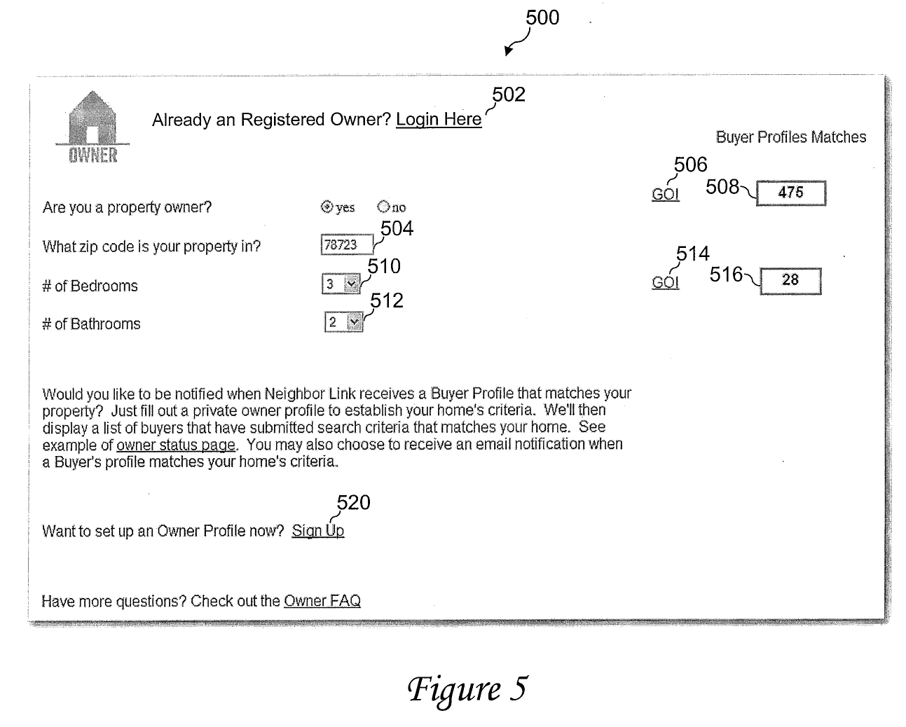

At block 304 of FIG. 3A, real property marketplace program code 126 enables the user to authenticate himself as a registered Owner that has previously established an owner profile with website 202. For example, in the embodiment of FIG. 5, in response to the selection of link 402, web server 200 presents an informational web page 500 containing a link 502 for which selection invokes the presentation of an authentication window in which the user may enter a unique username/password combination. If the user elects to authenticate himself as a registered Owner, the process passes through page connector B to block 330 of FIG. 3B, which is described below. If, however, the user does not authenticate as a registered Owner, the user is still permitted to explore potential interest in his property while remaining anonymous to both real property marketplace program code 126 and to potential buyers, as shown at blocks 306-312.

Specifically, at block 306, in response to receipt from the user of identification of a general location of the user's real property, matching engine 206 determines a number of buyer profiles in buyer database 210 that indicate interest in acquiring rights in property in the general location of the user's real property and provides the number to web server 200 for presentation within a web page. In the exemplary web page 500 shown in FIG. 5, the user identifies the location of his property by zip code via text box 504 and then selects link 506 to invoke operation of matching engine 206. Web server 200 presents a numerical result of the search in text box 508. It will be appreciated that although zip code may conveniently utilized to identify the location of the real property, in other embodiments, the location may be specified by other criteria (e.g., neighborhood/subdivision name, school district, school attendance area, city, etc.), by other technique (e.g., graphical selection of a geographical region on a map), and with greater or lesser geographical specificity.

To further encourage the user to establish an owner profile 213 within the online real property marketplace, the gross matching performed at block 306 optionally may be further refined based upon additional non-identifying descriptive information pertaining to the user's property, as shown at blocks 310 and 312. For example, if web server 200 receives additional description of the user's property, such as the number of bedrooms and bathrooms of the property, which may be entered via list boxes 510 and 512 of web page 500, web server 200 requests matching engine 206 to again search buyer database 210 for buyer profiles matching both the location and descriptive criteria in response to selection of link 514. Web server 200 then presents the numerical result of the refined search, for example, in text box 514.

Regardless of whether or not the user elects to input basic location and/or descriptive information regarding his property as depicted at blocks 306 and 310, the user preferably elects to establish an owner profile 213 within the real estate marketplace, as indicated at block 320. If not, the depicted process ends at block 322. If, however, the user elects to establish an owner profile 213, as indicated, for example, by the selection of link 520 of web page 500, web server 200 prompts the user (e.g., through a web form) to enter information to establish an owner profile 213. As is well known to those skilled in the art, the user may submit the requested information from client device 102 utilizing a keyboard, a graphical pointing device (e.g., mouse, touchscreen and stylus, or touchpad) that controls a cursor presented in a display device, and/or voice interface. In response to receipt of at least a minimum amount of information regarding the Owner and property (e.g., username, password, bedrooms, bathrooms and zip code) at block 324, web server 200 creates an owner profile 213 within owner database 212, as shown at block 326. Because many or most property owners will become sellers at the right price or under the right conditions, the user is likely to establish an owner profile 213 regardless of whether the user is actively attempting to sell the user's property or is committed to doing so because the owner controls the amount of information and the dissemination of information in the owner profile 213. The owner profile 213 preferably has a predetermined term for which it is maintained within owner database 212, such as 1 or 2 years.

The process proceeds from block 326 of FIG. 3A to block 330 of FIG. 3B, which depicts web server 200 invoking matching of the owner profile 213 with buyer profiles 211 in buyer database 210 by matching engine 206, as shown at block 332. Depending upon system-wide default settings and/or user-specific settings, the matching performed by matching engine 206 may be precise, thus returning as matches only those buyer profiles 211 that exactly match the property information contained within the owner profile 213, or may be imprecise, returning additional closely matching buyer profiles 211. If imprecise matching is enabled, matching engine 206 may return results to web server 200 in conjunction with ranking indicative of the relative closeness of the matching buyer profiles 211 to the property information in the owner profile 213.

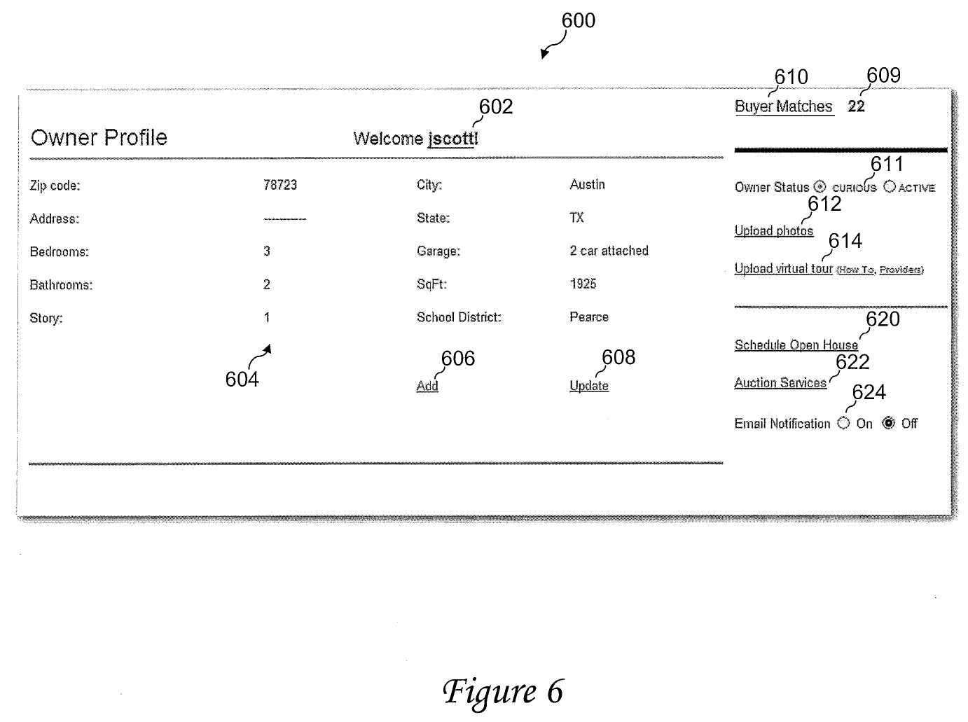

As further depicted at block 332, web server 200 presents to the user a view of the contents of the owner profile 213 created at block 326 (or in the case of a login by a previously registered Owner, retrieved from owner database 212). An exemplary embodiment of an owner profile web page 600 containing a view of the contents of an owner profile 213 is depicted within FIG. 6. In exemplary owner profile web page 600, the username of the user is presented, as shown at reference numeral 602. In addition, in a data area 604, various types of information about the property supplied by the Owner are presented. As indicated, the property information may include the property location (e.g., zip code, city and state), number of bedrooms and bathrooms, number of stories, garage size, square footage, and school district. It should be noted that the Owner may, but need not supply the physical address of the real property. In response to selection of link 606 or link 608, the Owner may respectively add additional information to owner profile 213 or update previously provided property information.

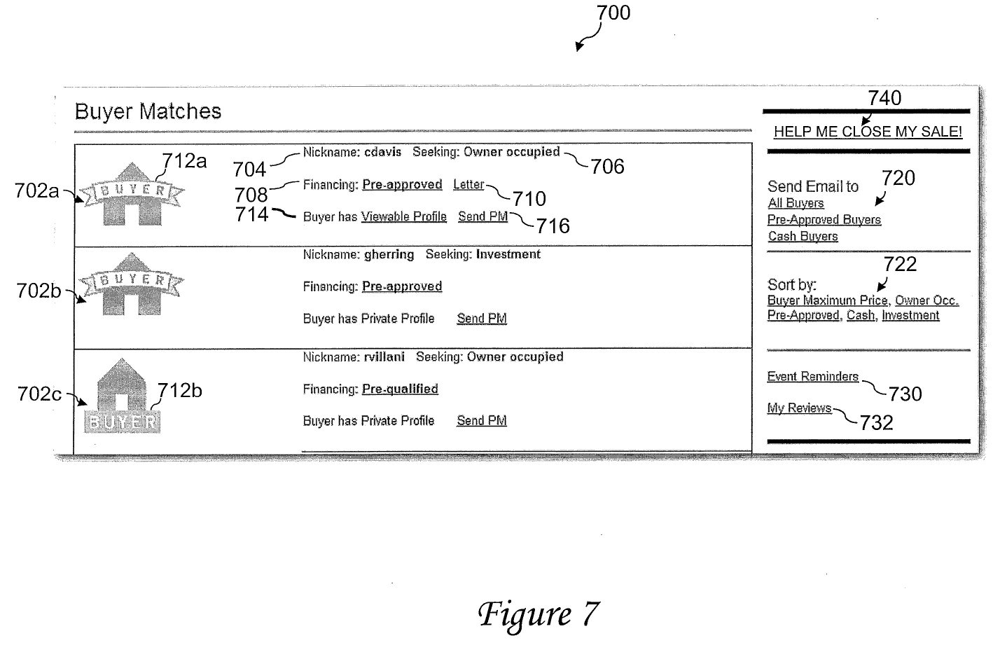

Owner profile web page 600 also summarizes a number of matching buyer profiles 211 currently residing within buyer database 210, as indicated at reference numeral 609. In association with this numerical summary, owner profile web page 600 presents a link 610 that may be selected by the user to invoke the presentation of an owner status web page (e.g., owner status web page 700 of FIG. 7) that lists information from some or all of the matching buyer profiles 211. In addition, owner profile web page 600 may optionally include facilities, such as links 612 and 614, which enable the user to augment the owner profile 213 by uploading photographs of the real property and a virtual tour of the real property, respectively. Owner profile web page 600 may further include facilities, such as links 620, 622 and radio button component 624, that enable the user to access services available through web site 200, such as scheduling an “open house” showing of the real property, arranging a live or electronically hosted auction of the real property, and enabling email notification by real property marketplace program code 126 and/or Buyers of buyer profiles 211 within buyer database 210 that match the owner profile 213. Owner profile 600 finally includes a facility (e.g., radio button component 611) that permits the user to control whether the information in data area 604, as well as any photos or virtual tour of the real property, are viewable by Buyers in the online real property marketplace. Thus, if radio button component 611 is set in the “curious” state, the information from owner profile 213 presented within data area 604 is private and not viewable by Buyers; if, on the other hand, radio button component 611 is set in the “active” state, the information from owner profile 213 presented within data area 604 is public and viewable by Buyers. Thus, the Owner has control over the amount of information within the owner profile 213, as well as over the dissemination of that information.

Returning to FIG. 3B, the process proceeds from block 332 to block 333, which depicts web server 220 depicting whether the Owner has indicated a desire to view information from matching buyer profiles 211, for example, by selecting link 610. If not, the process returns to blocks 330 and 332, which have been described. If, however, the Owner indicates a desire to view information from matching buyer profiles 211, web server 200 presents the information from the matching buyer profiles 211 in an owner status web page, as illustrated at block 334.

FIG. 7 illustrates an exemplary owner status web page 700 presented by web server 200 at block 334 of FIG. 3B. Exemplary owner status web page 700 contains three entries 702a-702c, each corresponding to a respective unique buyer profile 211 within buyer database 210 that matches the property information within the owner profile 213. Each entry 702 identifies the username of the potential buyer, as shown at reference number 704, and, as indicated at reference numeral 706, the property use for which the potential buyer is seeking to purchase property (e.g., owner occupied or investment). Entry 702 preferably further indicates the financing available to the prospective buyer (e.g., pre-approved, pre-qualified, cash or not yet qualified), as depicted at reference numeral 708. If enabled by the prospective buyer, entry 702 may further include a facility (e.g., link 710) that permits the owner to verify the financing by viewing an electronic copy of a mortgage approval letter, bank balance letter, etc. forming a portion of the buyer profile 211 of the prospective buyer. The status of the prospective buyer as a cash buyer or pre-approved buyer may further be emphasized by a graphical status indication 712a that is distinct from the graphical status indication 712b of a pre-qualified or not yet qualified buyer.

Certain prospective buyers desiring to promote themselves to owners and distinguish themselves from other prospective buyers may also make their buyer profiles 211 viewable (except for any information designated as private), and owners may view such viewable buyer profiles 211, for example, by selecting a link within entry 702, as indicated at reference numeral 714. Buyers may also promote themselves by paying a monetary fee to achieve a higher rank in the listing of entries 702. Entry 702 finally preferably includes a link 716 (or other component) that permits the owner to initiate transmission of a personal electronic mail (email) message to the prospective buyer via email server 204. It will be appreciated that the personal email communication can be conducted utilizing email address aliasing to maintain the anonymity of owner and/or prospective buyer until either party desires to divulge his contact information to the other.

Owner status web page 700 may also support a broadcast email capability by which an owner can send an email message to all or particular buyer classes (e.g., pre-approved or cash financed buyers) listed within owner status web page 700, as depicted at reference numeral 720. The order of presentation of entries 702 within owner status web page 700 by web server 200 may also be controlled by the user via links or other components, as depicted at reference numeral 722. The Owner can also view event reminders for events scheduled by or for the Owner (e.g., open house showings or real property auction) by selecting link 730 and may view his annotations regarding particular properties by selecting link 732.

Returning to FIG. 3B, once web server 200 presents an owner status web page, such as owner status web page 700 of FIG. 7, web server 200 permits the owner to browse and annotate buyer entries 702 as previously described (block 340). It should be emphasized that the owner can do so completely anonymously until the owner is ready and willing to make public disclosure of his desire to sell by contacting one or more prospective Buyers by email or by enabling the public disclosure of the contents of his owner profile 213 utilizing radio button component 611. If, however, the Owner elects to reveal information regarding himself or his real property, for example, by sending an email to one or more prospective buyers or by permitting the viewing of information from his owner profile 213, email server 204 or web server 200 provides the desired communication, as illustrated at block 342 and 344. If the communication leads to a desire on the part of the Owner to sell or otherwise convey rights in the real property, the Owner may selecting link 740 to access information describing particular property-related service providers (e.g., real estate brokers, attorneys, title companies, surveyors, property inspectors, mortgage brokers, etc.) in service provider database 220 and/or forms wizard 226. In a preferred embodiment, the service providers may be required to pay a fee and/or guarantee a fixed price to perform specified services in order to obtain a listing in service provider database 220. In order to promote a higher level of service by service providers, Owners and Buyers participating in the online real property marketplace are also preferably permitted to provide community-viewable feedback regarding the services and service providers listed within service provider database 220.

The process illustrated in FIG. 3B and the owner's session with web server 200 continues until the owner elects to exit website 202 (block 350), for example, by navigating to a different website utilizing browser 114 or by explicitly logging off website 202. Thereafter, the process terminates at block 352.

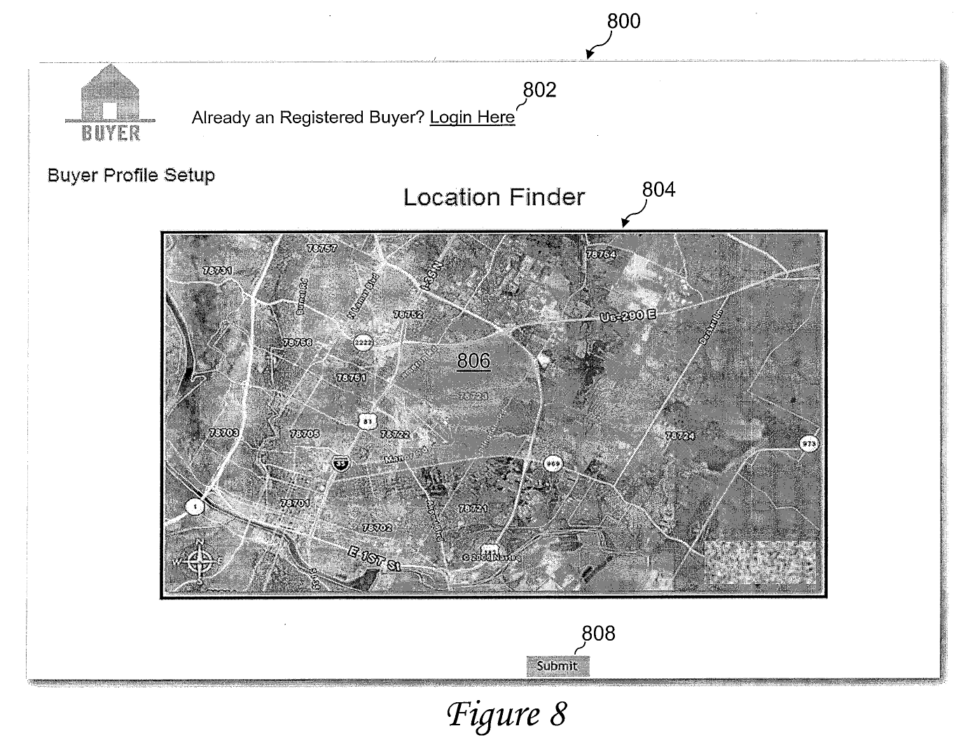

Referring again to block 302 of FIG. 3A, in response to the user utilizing a navigation facility of home page 400 to navigate to the Buyer portion of website 202 (e.g., by “clicking” on link 404 of home page 400), the process passes through page connector A to block 360 of FIG. 3C. At block 360 of FIG. 3C, real property marketplace program code 126 enables the user to authenticate himself to web server 200 as a registered Buyer that has previously established a buyer profile 211 with the online real property marketplace. For example, in the embodiment of FIG. 8, in response to the selection of link 404, web server 200 presents a property location web page 800 containing a link 802 for which selection invokes the presentation of an authentication window in which the user may enter a unique username/password combination. If the user elects to authenticate himself as a registered Buyer, the process passes from block 360 to block 382, which is described below. If, however, the user does not authenticate as a registered Buyer, the user is permitted to establish a buyer profile 211, as shown at block 362. If the user elects not to establish a buyer profile 211, the illustrated process terminates at block 364. If, on the other hand, the user elects to establish a buyer profile 211, the process proceeds to block 370 and following blocks, which represent web server 200 gathering information to create a buyer profile 211.

Block 370 depicts the user entering and web server 200 receiving one or more possible locations for a desired property, for example, by zip code, neighborhood/subdivision name, school district, school attendance area, city, etc. In exemplary web page 800 of FIG. 8, web server 200 enables the user to identify one or possible locations of real property in which the user may desire to acquire rights via a graphical map interface 804 that supports graphical selection of geographic regions by zip code. As with conventional map interfaces commonly used on Internet websites, the user may pan the view of the map and may control the magnification at which the map is presented within map interface 804. Selected geographic regions are preferably highlighted or otherwise displayed in a visually distinct manner within map interface 804, as indicated at reference numeral 806. Once the user has selected one or more geographic regions of interest, the user may select button 808 to submit his selected geographical region(s) to web server 200.

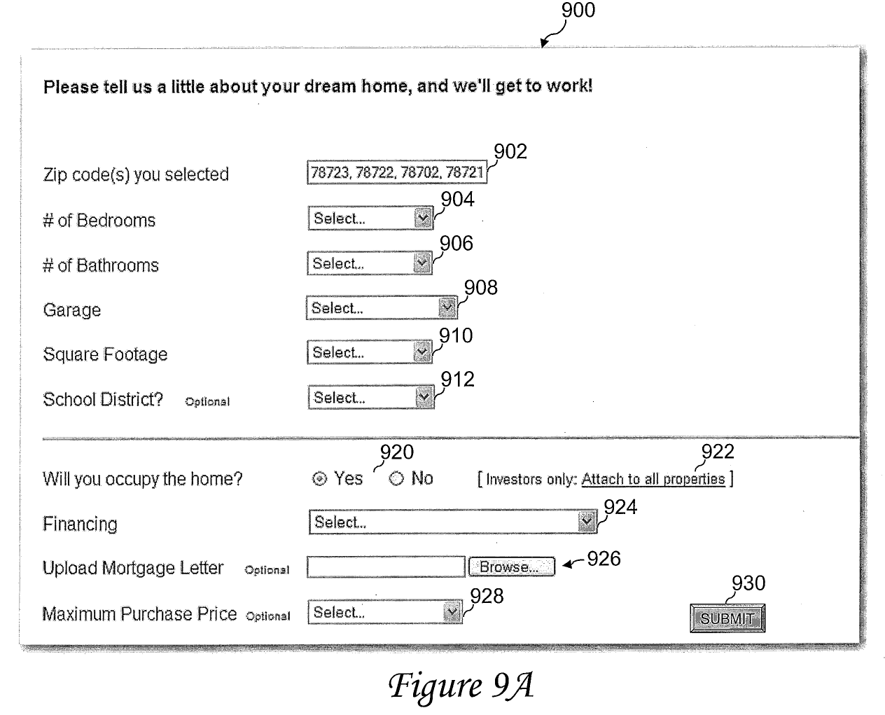

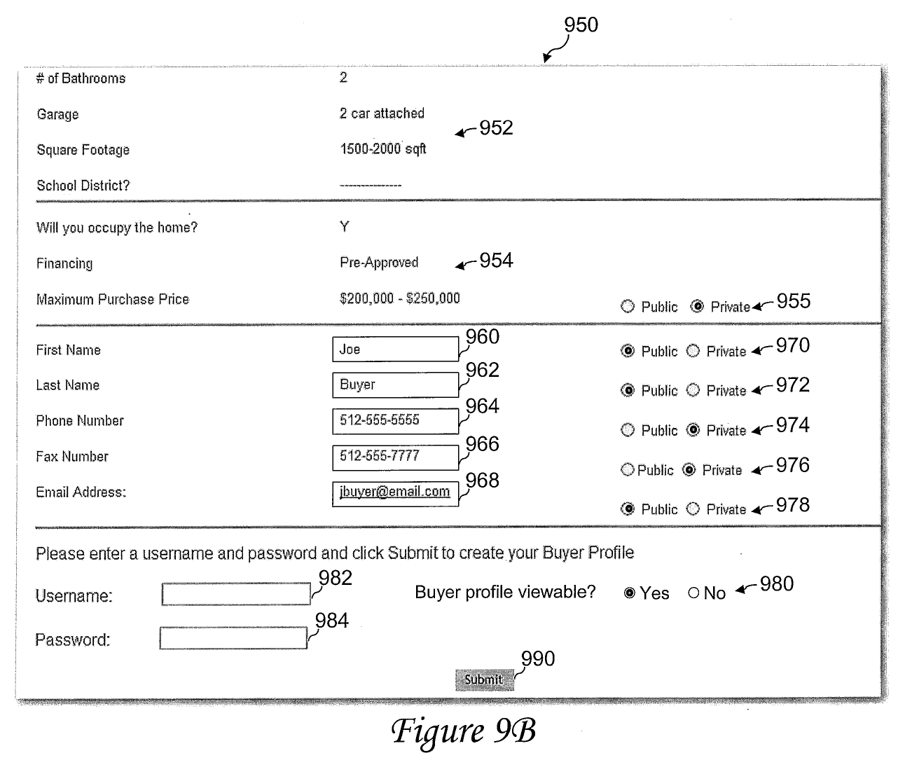

In addition to permitting the Buyer to enter possible geographic locations for a property, web server 200 also enables the Buyer to enter information describing attributes of real property that would be desirable to the Buyer (block 372 of FIG. 3C). In one embodiment of the present invention, web server 200 enables entry of such attributes through buyer query web page 900 of FIG. 9A, which web server 200 presents in response to selection of button 808 of web page 800. Web page 900 includes a location text box 902 that the user populates either utilizing map interface 804 or by typing the desired zip code(s) into location text box 902. Using pick lists 904, 906, 908, 910 and 912, respectively, the user may also enter the number of bedrooms and bathrooms, garage size, square footage range, and optionally, the school district of a desired property. One or more of pick lists 904-912 may include an “Any” entry to allow the Buyer to indicate that no potential property matches should be excluded on the basis of the associated attribute.

Web server 200 also gathers financially related information from the Buyer, as indicated at block 374 of FIG. 3C, for example, through the lower portion of web page 900 of FIG. 9A. In the exemplary embodiment, web page 200 receives information indicating whether or not the property will be owner-occupied via radio button component 920, receives an indication of the Buyer's financing status (e.g., pre-qualified, pre-approved, cash, not yet qualified) via pick list 924, and receives an optional maximum purchase price range via pick list 928. For Buyers indicating that the desired property will not be owner-occupied, web server 200 provides a link 922 in web page 900 that permits the Buyer to indicate that the resulting buyer profile 211 should be considered a match for every owner profile 213 located within the geographical region identified by text box 902. Web page 900 further includes a document upload facility 926 that permits the Buyer to optionally upload documentation (e.g., a mortgage approval letter or bank balance letter) demonstrating the veracity of his claimed financing status. When the Buyer has completed web page 900, the Buyer submits and web server 200 receives the entered information in response to selection of button 930.

Returning to FIG. 3C, web server 200 also requests and receives from the Buyer potentially private personal information of the Buyer, as indicated at block 376. In one embodiment, in response to selection of button 930 of FIG. 9A, web server 200 presents buyer query web page 950, which prompts the Buyer to enter personal information. In the exemplary implementation, web page 950 initially presents property information in data area 952 and financially related information in data area 954 that were previously entered via web page 900. The Buyer may utilize radio button component 955 to indicate whether the Buyer's maximum purchase price range is private (and therefore only viewable by the Buyer) or public (and therefore viewable by Owners in the online real estate marketplace). Web server 200 thereafter requests and the Buyer enters personal information such as the Buyer's first and last names, phone number, fax number and email address via text boxes 960-968 in web page 950. Each of these pieces of personal information has a respective associated one of radio button components 970-978 that permits the Buyer to designate that piece of personal information as either private or public, with the attendant implications on the potential dissemination of that information. Web page 950 preferably further includes a global control, such as radio button control 980, that governs whether any of the information in the buyer profile 211 to be created will be public or private. Thus, the Buyer has control over the amount of information within the buyer profile 211, as well as over the dissemination of that information.

Finally, web page 950 enables the Buyer to establish a unique username/password combination to authenticate the Buyer's identity using text boxes 982 and 984. When the Buyer has completed web page 950, the Buyer submits and web server 200 receives the entered information in response to selection of button 990.

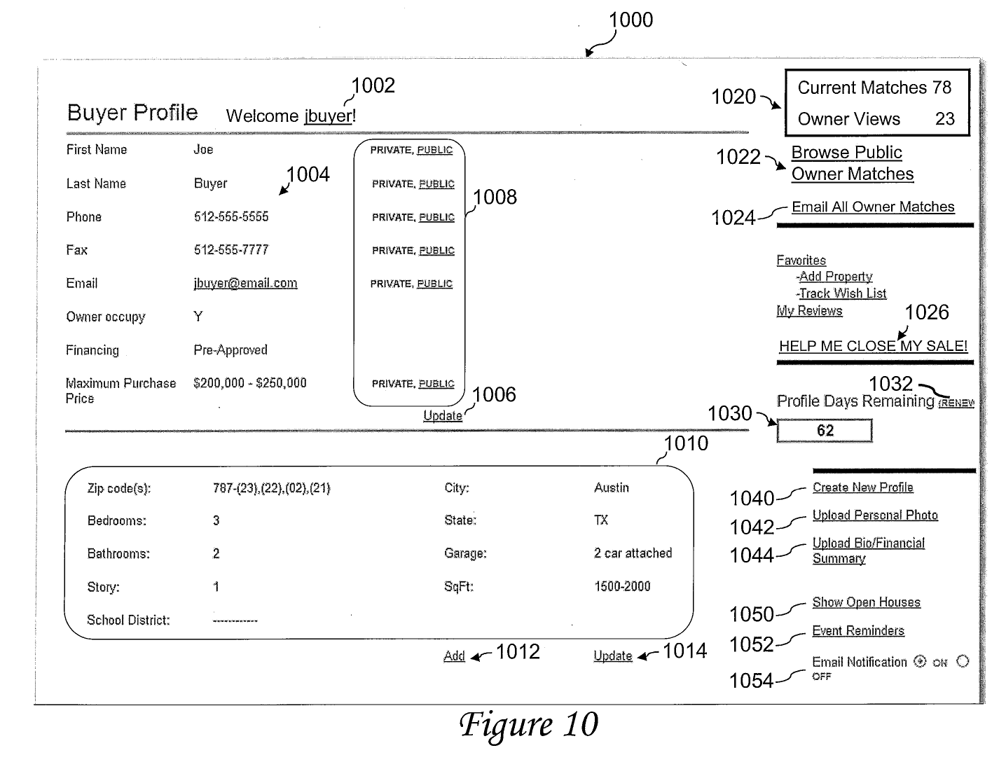

In response to receipt of the information from the Buyer at blocks 370-376, web server 200 creates a buyer profile 211 for the Buyer in buyer database 210, as depicted at block 380 of FIG. 3C. Web server 200 also invokes the operation of matching engine 206 to match the buyer profile 211 (i.e., the buyer profile 211 created at block 380 or the buyer profile 211 of an authenticated Buyer retrieved from buyer database 210) against owner profiles 213 in owner database 212, as illustrated at block 382. Based upon the information received by web server 200 from the Buyer and the results of matching engine 206, web server 200 presents a buyer profile web page, as depicted at block 384 of FIG. 3C. In one embodiment the buyer profile web page presented at block 384 may be implemented as depicted in FIG. 10.

Referring now to FIG. 10, exemplary buyer profile web page 1000 presents the username of the Buyer, as shown at reference numeral 1002. In addition, in first data area 1004, web server 200 presents various types of personal and financially related information supplied by the Buyer via web pages 900 and 950. Buyer profile web page 1000 preferably includes a component, such as link 1006, in order to permit the Buyer to update the information presented within first data area 1004, and component(s), such as links 1008, in order to permit the Buyer to update the public/private status of the Buyer's personal and financially related information.

Web page 1000 further includes a second data area 1010 that presents attributes of the Buyer's desired property, such as property location (e.g., zip code, city and state), number of bedrooms and bathrooms, number of stories, garage size, square footage, and optionally, a school district. The Buyer can augment or update the property attributes within second data area 1010 via component(s) in web page 1000, such as links 1012 and 1014. If desired, the Buyer can also initiate creation of a new buyer profile 211, for example, by selecting link 1040.

In accordance with the present invention, the buyer profile 211 expires (unless renewed) after a predetermined term (e.g., 90 days), which is preferably shorter in duration than the lifetime of owner profiles 213. Web server 200 reports the number of days remaining until the buyer profile 211 expires within text box 1030 so that, if interested, the Buyer can renew the buyer profile 211 for an additional term prior to its expiration by simply selecting link 1032.

Buyer profile web page 1000 also summarizes a number of matching owner profiles currently residing within owner database 212 and a number of views of the Buyer's information (e.g., by an Owner selecting a link 714 in an entry 702 in an owner status web page 700), as shown at reference numeral 1020. In association with this numerical summary, buyer profile web page 1000 presents a link 1022 that may be selected by the user to invoke the presentation of publicly viewable matching owner profiles 211. As noted above, the viewable owner profiles 211 are only those that the Owner has designated as such utilizing radio button component 611. The Buyer may also send an email message to all Owners having matching owner profiles 213 (regardless of whether the Owners' profiles are viewable) expressing interest in exploring purchase of the Owners' properties. As noted above, an Owner will only receive such emails if the Owner has selected to receive email notification, for example, via radio button component 624 in the owner profile web page 600.

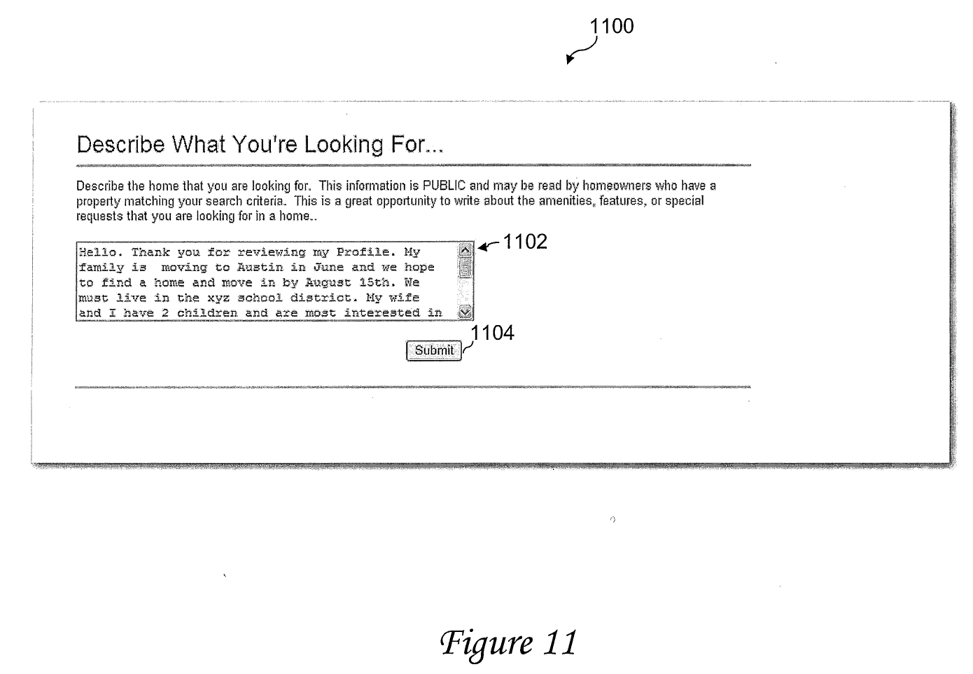

In addition, buyer profile web page 1000 may optionally include facilities, such as links 1042 and 1044, which enable the user to augment the buyer profile 211 by uploading a personal photograph and/or a personal statement, such as a biographical and/or financial summary statement. For example, in response to user selection of link 1044, web server 200 presents web page 1100 of FIG. 11, which includes a text box 1102 into which the Buyer is permitted to enter a textual biographical or financial summary statement. The contents of text box 1102 are appended to the buyer profile 211 in response to user selection of button 1104.

Buyer profile web page 1000 may further include facilities, such as links 1050, 1052 and radio button component 1054, that enable the Buyer to access services available through web site 200, such receiving information regarding “open house” showings of real property of Owners, viewing reminders of events, and enabling email notification by Owners and/or the online real property marketplace of real property that potentially matches the buyer profile 211. Like Owners, the Buyer may also access information describing particular property-related service providers (e.g., real estate brokers, title companies, surveyors, property inspectors, mortgage brokers, etc.) in service provider database 220 and/or forms wizard 226 by selecting link 1026.

As indicated at block 386 of FIG. 3C, while web server 200 presents buyer profile web page 211, the Buyer is able to investigate and access a variety of services available to Buyers participating in the online real property marketplace, as described above with reference to FIG. 10. If the Buyer elects to exit website 200 at block 390, for example, by navigating to another website or explicitly logging out of website 200, the process terminates at block 392. If, on the other hand, the Buyer does not exit website 200, the process returns to block 382 and following blocks, which have been described.

It will further be appreciated that a fee-based subscription for access to website 200 can be charged to some or all parties. In addition, revenue can be generated from the website through the sale of advertising on the website. The presentation of advertising can be customized based upon an entered address or geographic region (i.e., location-based) so that advertisements of companies geographically closer to the entered address are more prominently or frequently presented. Such advertising can also be customized based upon customer feedback so that advertisements of companies with better customer feedback are more prominently or frequently presented.

As has been described, the present invention includes methods, systems, and program products that provide an improved online real estate marketplace that facilitates communication between Owners and Buyers. The online real estate marketplace enables Owners to explore sale or conveyance of rights in their properties without first entering into a conventional MLS listing agreement with a real estate broker. In addition, the online real estate marketplace enables Buyers to express possibly unsolicited interest in some or all properties in a specified geographic area, not merely properties that are listed as for sale or for lease. Owners and Buyers participating in the online real estate preferably control dissemination of information they supply to the online real estate marketplace and may participate in the marketplace and actively explore transactions while remaining anonymous to other parties. Thus, in at least some sale scenarios, the conventional paradigm of anonymous buyers being permitted to view and evaluate the property of a completely publicly disclosed property seller is reversed, and anonymous Owners are permitted to anonymously view and evaluate profiles of Buyers providing varying levels of disclosure of information including complete public disclosure of personal and financial information. It should be noted that in such scenarios, the Owner need not even have decided that his real property is “on the market” to attract interested Buyers or evaluate likely sale prices/scenarios.

While the invention has been particularly shown as described with reference to a preferred embodiment, it will be understood by those skilled in the art that various changes in form and detail may be made therein without departing from the spirit and scope of the invention. For example, although the exemplary web pages illustrated herein contain particular graphical user interface elements, those skilled in the art will appreciate that many equivalent graphical or textual components could be alternatively or additionally employed to gather user input, to create buyer and owner profiles, to access services of the online real property marketplace, or perform others of the described functions.

In addition, it should be understood that the depicted property attributes (e.g., number of bedrooms, bathrooms, etc.) are merely illustrative and not exhaustive. In some embodiments, the buyer profile may further permit the user to designate some property criteria (e.g., dwelling size or bedrooms) as mandatory and others are merely preferences. In alternative embodiments, no such designation is made and a “best fit” of the specified attributes is employed.

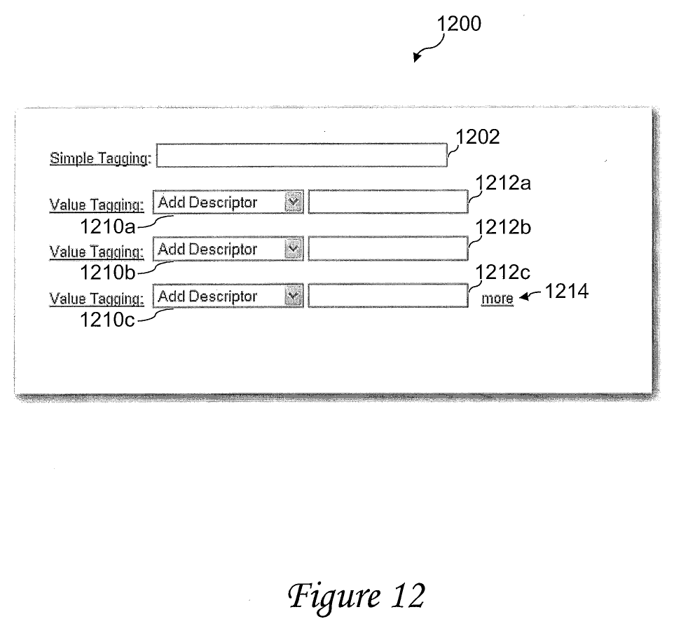

The quality of the matching achieved by the online real property marketplace can also be enhanced by the optional inclusion within owner profiles and buyer profiles of system-defined and/or user-defined tags describing the real property or the rights in the real property. For example, in one embodiment, web server 200 may present a web page 1200 as shown in FIG. 12 in response to selection of a tagging component in owner profile web page 600 or buyer profile web page 1000. The Owner or Buyer is permitted to associate one or more user-selected keywords with his profile (e.g., “new appliances”, “trees”, “waterfront”, “exemplary schools”, “zoned MF-4”, “hunting lease”, etc.) by entering the keyword(s) in keyword text box 1202. The Owner or Buyer may provide more detailed information through entering one or more descriptor:value pairs via descriptor combination boxes 1210a-1210c and associated value text boxes 1212a-1212c. That is, the user can select a preexisting descriptor from a pick list accessible in a descriptor combination box 1210 or can create a new descriptor by typing the descriptor into a combination box 1210. The user can then define a value for the descriptor by entering the value in the associated value text box 1212. Any number of descriptor:value pairs may be defined for an owner or buyer profile through link 1214.

Thus, for example, an Owner or Buyer may enter the simple keyword “maple trees” into keyword text box 1202. Alternatively, the Owner or Buyer may enter the descriptor “trees” and associate with it the value “maple” utilizing a descriptor combination box 1210 and value text box 1212. In either case, matching engine 206 preferably supports best-fit matching between keywords and between keywords and descriptor:value pairs to enhance the quality and ordering of the entries 702 returned in owner status web page 700 or browsed by a Buyer via link 1022.

Utilizing tagging as described herein would allow the subscriber base to itself generate appropriate terminology to describe every type of real estate, eliminating the need for the operator of website 200 to create separate property classifications for each type of real property and/or interest in real property. Supporting tagging as described also enables consumers to use Really Simple Syndication (RSS) readers to “attach to” or receive RSS feeds from website 200, thereby promoting publicly viewable owner-supplied property descriptions and buyer profiles beyond website 200.

Further, it will be appreciated that the present invention is applicable to all types of real property (e.g., residential, commercial, agricultural, etc.) and to the transfer or acquisition of all types of interests (e.g., fee simple ownership, residential or commercial leasehold, oil and gas lease, hunting rights, cell tower leases, grazing rights, easements, etc.) in real property.

In addition, although aspects of the present invention have been described with respect to a data processing system processing program code that directs the functions of the present invention, it should be understood that present invention may alternatively be implemented as a program product containing program code for use with a data processing system. Program code defining the functions of the present invention can be written in any known or future developed language and can be delivered to a data processing system via a variety of computer-readable media, which include, without limitation, non-rewritable storage media (e.g., CD-ROM), rewritable storage media (e.g., a floppy diskette or hard disk drive), and communication media, such as digital and analog networks. It should be understood, therefore, that such computer-readable media, when carrying or encoding computer readable instructions that direct the functions of the present invention, represent alternative embodiments of the present invention. It will further be appreciated that alternative embodiments of the present invention, may implement the program code utilizing a peer-to-peer architecture rather than a client/server architecture.

What is claimed is:

1. A method of data processing in a data processing system, said method comprising:
establishing a plurality of buyer profiles, wherein each buyer profile describes one or more attributes of a real property in which a buyer desires to acquire an interest;
establishing at least one owner profile in which an owner describes real property in which an owner holds rights;
comparing contents of the owner profile against the plurality of buyer profiles to obtain at least one closely matching buyer profile; and
transmitting information from said at least one matching buyer profile for presentation to said owner.

2. The method of claim 1, wherein said transmitting information comprises transmitting a web page containing said information from said at least one matching buyer profile.

3. The method of claim 1, and further comprising:
prior to establishment of said at least one owner profile, receiving from the owner at least an indication of a location of said property and, responsive thereto, providing an indication of a number of buyer profiles matching said location.

4. The method of claim 1, and further comprising:
prior to establishment of said at least one owner profile, receiving from the owner at least attribute of said property and, responsive thereto, providing an indication of a number of buyer profiles matching said at least one attribute.

5. The method of claim 1, wherein said establishing said at least one owner profile comprises establishing said at least one owner profile in absence of a listing agreement.

6. The method of claim 1, wherein:
establishing a plurality of buyer profiles, establishing at least one owner profile, comparing contents of the owner profile against the plurality of buyer profiles, and transmitting information are performed by a server system; and
said establishing a plurality of buyer profiles comprises establishing a particular buyer profile among said plurality of buyer profiles in response to receiving said one or more attributes of a real property in which the particular buyer desires to acquire an interest from a client device.

7. The method of claim 1, and further comprising:
in response to a request by the owner, communicating an electronic message to one or more buyers designated by the owner.

8. The method of claim 1, and further comprising:
in response to a user input, transmitting information to a client device regarding one or more property-related services.

9. The method of claim 1, wherein:
said method further comprises associating a user-defined tag with a buyer profile in response to a user input; and
said comparing comprises comparing the user-defined tag with the contents of the owner profile to identify the buyer profile as a closely matching buyer profile.

10. A data processing system, comprising:
processing resources;
data storage coupled to the processing resources, said data storage including program code that when processed by the processing resources causes the data processing system to perform a method including:
establishing a plurality of buyer profiles, wherein each buyer profile describes one or more attributes of a real property in which a buyer desires to acquire an interest;
establishing at least one owner profile in which an owner describes real property in which an owner holds rights;
comparing contents of the owner profile against the plurality of buyer profiles to obtain at least one closely matching buyer profile; and
transmitting information from said at least one matching buyer profile for presentation to said owner.

11. The data processing system of claim 10, wherein said transmitting information comprises transmitting a web page containing said information from said at least one matching buyer profile.

12. The data processing system of claim 10, wherein prior to establishment of said at least one owner profile, the data processing system receives from the owner at least an indication of a location of said property and, responsive thereto, provides an indication of a number of buyer profiles matching said location.

13. The data processing system of claim 10, wherein prior to establishment of said at least one owner profile, the data processing system receives from the owner at least attribute of said property and, responsive thereto, provides an indication of a number of buyer profiles matching said at least one attribute.

14. The data processing system of claim 10, wherein said establishing said at least one owner profile comprises establishing said at least one owner profile in absence of a listing agreement.

15. The data processing system of claim 10, wherein:
the data processing system comprises a server system; and
said establishing a plurality of buyer profiles comprises establishing a particular buyer profile among said plurality of buyer profiles in response to receiving said one or more attributes of a real property in which the particular buyer desires to acquire an interest from a client device.

16. The data processing system of claim 10, wherein the server system, in response to a request by the owner, communicates an electronic message to one or more buyers designated by the owner.

17. The data processing system of claim 10, wherein said data processing system, in response to a user input, transmits information to a client device regarding one or more property-related services.

18. The data processing system of claim 10, wherein:
said data processing system associates a user-defined tag with a buyer profile in response to a user input; and
said data processing system compares the user-defined tag with the contents of the owner profile to identify the buyer profile as a closely matching buyer profile.

19. A program product for enabling an online real property marketplace, said program product comprising:
a computer-readable storage medium; and
program code stored within the computer-readable storage medium that, when processed by a data processing system, causes the data processing system to perform a method including:
establishing a plurality of buyer profiles, wherein each buyer profile describes one or more attributes of a real property in which a buyer desires to acquire an interest;
establishing at least one owner profile in which an owner describes real property in which an owner holds rights;
comparing contents of the owner profile against the plurality of buyer profiles to obtain at least one closely matching buyer profile; and
transmitting information from said at least one matching buyer profile for presentation to said owner.

20. The program product of claim 19, wherein said transmitting information comprises transmitting a web page containing said information from said at least one matching buyer profile.

21. The program product of claim 19, the method further comprising:
prior to establishment of said at least one owner profile, receiving from the owner at least an indication of a location of said property and, responsive thereto, providing an indication of a number of buyer profiles matching said location.

22. The program product of claim 19, the method further comprising:
prior to establishment of said at least one owner profile, receiving from the owner at least attribute of said property and, responsive thereto, providing an indication of a number of buyer profiles matching said at least one attribute.

23. The program product of claim 19, wherein said establishing said at least one owner profile comprises establishing said at least one owner profile in absence of a listing agreement.

24. The program product of claim 19, wherein:
the data processing system comprises a server system; and
said establishing a plurality of buyer profiles comprises establishing a particular buyer profile among said plurality of buyer profiles in response to receiving, from a client device, said one or more attributes of a real property in which the particular buyer desires to acquire an interest.

25. The program product of claim 19, said method further comprising:
in response to a request by the owner, communicating an electronic message to one or more buyers designated by the owner.

26. The program product of claim 19, said method further comprising:
in response to a user input, transmitting information to a client device regarding one or more property-related services.

27. The program product of claim 19, said method further comprising:
associating a user-defined tag with a buyer profile in response to a user input; and
comparing the user-defined tag with the contents of the owner profile to identify the buyer profile as a closely matching buyer profile.
